(19) United States
(12) Patent Application Publication
(10) Pub. No.: US 2008/0281552 A1
(43) Pub. Date: Nov. 13, 2008

(54) Method for the Detection of the Loading of a Motor Vehicle

(75) Inventors: Markus Irth, Mainz-Kastel (DE); Andreas Kobe, Bensheim (DE); Christian Sussmann, Oberursel (DE); Franko Blank, Hodenhang (DE); Vladimir Koukes, Darmstadt (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 12/093,615

(22) PCT Filed: Nov. 14, 2006
(86) PCT No.: PCT/EP06/68438

§ 371 Date: May 14, 2008

(30) Foreign Application Priority Data
Nov. 14, 2005 (DE) 10 2005 054 555.6
Nov. 14, 2006 (DE) 10 2006 053 827.7

(51) Int. Cl. G01M 17/02

(52) U.S. Cl. 702/138; 73/146

(57) ABSTRACT

A method for the detection of the loading of a motor vehicle determines a loading condition of the vehicle using an analysis of the rotational behavior of the wheels. In a frequency analysis, it determines the natural frequencies of the wheels and looks at the amplitudes of the tire noise around those frequencies, which amplitudes change when the loading condition changes.

### BACKGROUND OF THE INVENTION

The present invention relates to a method to detect the loading conditions of a vehicle.

In up-to-date motor vehicles, electronic systems for improving the safety of the vehicle are employed at an increasing rate. For example, vehicles which are not equipped with an anti-lock system (ABS) are hardly sold within Europe. Further known systems such as electronic stability program (ESP), traction control (TCS), electronic brake force distribution (EBD), active chassis (ABC: Active Body Control), active rollover protection (ARP: Active Rollover Prevention), headlight-range adjustment, and tire pressure monitoring systems are offered at least as an optional vehicle equipment in a large number of vehicles. As is generally known, the loading of a vehicle increases the load on the tires, the vehicle mass and the inertia of the vehicle. Thus, loading has manifold effects on the vehicle performance, vehicle handling and safety. Knowing about the loading of the vehicle allows improving the mentioned systems e.g. with regard to their control algorithms, with the result that the safety of the vehicle is further enhanced.

So-called directly measuring tire pressure monitoring systems are known in the art, as described in the application DE 199 26 616 C2, for example, which use pressure sensors in the individual tires to detect the respective pressure in the associated wheel. Furthermore, so-called indirectly measuring tire pressure monitoring systems (DDS: Deflation Detection System) are known, as e.g. described in DE 100 58 140 A1, which can determine pressure loss from auxiliary quantities, for example by comparing the rolling circumferences of the individual wheels.

EP 0 578 826 B1 discloses a device for determining tire pressure which detects pressure loss in a tire based on tire oscillations.

WO 01/87647 A1 describes a method and a device for tire pressure monitoring, combining a tire pressure monitoring system which is based on the detection of wheel radii, and a tire pressure monitoring system which is based on the evaluation of oscillation properties.

In the known tire pressure monitoring systems, heavy loading of the vehicle e.g. causes an additional force that acts on the tires (increased wheel contact force), which leads to a deformation and a change in the rolling performance of the tires. The high amount of force applied can have the same negative effects (tire damages, changes of the driving performance, etc.) like insufficient tire inflation pressure. The change of the rolling performance of the wheels will not be noticed in a directly measuring tire pressure monitoring system because the heavy loading does not have any effect on the measured tire inflation pressure. Consequently, tire damage can occur during driving in the event of excessively heavy loading in spite of an existing directly measuring tire pressure monitoring system.

In an indirectly measuring tire pressure monitoring system, it may occur that vehicle parameters (e.g. rolling circumferences of the wheels) are learnt incorrectly during the system-induced learning operation if, for example, the vehicle is loaded on one side during the learning operation. This wrong learning operation can cause a false alarm after data have been taught in and with a changed loading.

In both cases, the tire pressure monitoring system is required to take the loading into consideration in order to be able to report the cause of an error (inflation pressure or loading) to the driver. Otherwise, a warning which is produced by the system due to heavy loading can be misinterpreted by the driver as being false after an inflation pressure check at the gas station.

In view of the above, an object of the invention is to provide a method of detecting the state of loading of a motor vehicle or a change of loading in a motor vehicle, which serves to improve the control algorithms and/or warn in electronic systems, such as anti-lock system, electronic stability program, traction control, active body control, active rollover protection, electronic brake force distribution, or tire pressure monitoring, or which can be used for the plausibilisation of other methods of loading detection.

### SUMMARY OF THE INVENTION

According to the invention, this object is achieved by analysing the rotational behavior of the wheels.

The invention is based on the idea that the rotational behavior of the wheels of a vehicle is influenced by different physical effects, which at least partly depend differently on the change of the wheel load. It is thus possible to detect a loading of the motor vehicle and/or a change of the loading of the vehicle by means of an appropriate analysis of the rotational behavior of the wheels.

According to a preferred embodiment of the method of the invention, the loading and/or change of loading is determined by combining pieces of information from a rolling circumference analysis of the wheels with information of a frequency analysis of the natural oscillation behavior of the wheels. This is favorable because the rolling circumferences of wheels change by a change of the wheel load, whereas a frequency spectrum of a wheel is not changed by a change of the wheel load, at least with respect to some characteristic quantities, e.g. the natural frequency.

It is therefore preferred that a natural frequency is determined in the frequency analysis for at least one wheel, and this natural frequency or a change of the natural frequency is used to detect the loading and/or change of loading. It is especially preferred in this arrangement when the natural frequency is determined for each wheel.

According to a preferred improvement of the invention, a reference quantity, which represents an indicator of the configuration of the natural frequency, is determined in the frequency analysis for at least one wheel, and this reference quantity (these reference quantities) or a ratio of reference quantities is used to detect the loading and/or change of loading. With particular preference, the magnitude of the change of the reference quantity (quantities) or the magnitude of the change of the ratio of reference quantities is evaluated. It is likewise especially favorable when such a reference quantity is determined for each wheel. The energy content of the spectrum in the range of the natural frequency is used as a reference quantity with particular preference. To this end, it is especially preferred for the amplitude of the frequency spectrum to be taken into consideration in the natural frequency or the energy content of the frequency spectrum in a predetermined frequency range.

A ratio of reference quantities between front wheels and rear wheels is preferred to be employed for the detection of the loading and/or change of loading. In an especially preferred fashion, the ratio of energy content of a front-wheel spectrum in the range of the natural frequency to the energy content of a rear-wheel spectrum in the range of the natural frequency is employed. It is likewise particularly favorable to evaluate the magnitude of the change of the ratio.

It is furthermore preferred to carry out a temperature compensation of the results of the frequency analysis. The purpose is to prevent the quantities obtained from the frequency spectrum from being influenced by the temperature.

Preferably, the method of the invention is performed only after an activation signal. The detection of the loading and/or change of loading are/is especially preferred to be initiated only after standstill of the vehicle.

According to a favorable improvement of the invention, the detection of the loading and/or change of loading is employed to improve the warning algorithms and/or control algorithms in at least one electronic system, especially in an anti-lock system, electronic stability program, an indirect or direct tire pressure monitoring system.

Preferably, information from a directly measuring tire pressure monitoring system is additionally evaluated for the detection of the loading and/or change of loading. This allows achieving an additional improvement of the loading detection.

When using the method of the invention to improve an indirect tire pressure loss detection system, which is based on a rolling circumference analysis, it is preferred to suppress a pressure loss warning when a change in loading is identified. In this case, it is especially preferred to learn in compensation values for the rolling circumference analysis variables and to release the pressure loss warning again after compensation has taken place.

One advantage of the method of the invention can be seen in that a detection of loading and/or a change of loading are/is performed only by evaluation of the wheel rotational speed signals of the wheels, which usually are determined already in an anti-lock system and are thus available. This allows realizing the method of the invention at low cost. The information about the state of loading can then be sent to one or more electronic systems, e.g. an indirectly or directly measuring tire pressure monitoring system. Thus, the method offers the advantage of improving different systems with little effort and costs.

The invention also relates to a computer program product which defines an algorithm according to the method described hereinabove.

Further preferred embodiments can be seen the following description by way of the Figures.

### BRIEF DESCRIPTION OF THE DRAWINGS

In the accompanying drawings,

FIG. 1 is a flow chart of the method of the invention;

FIG. 2 is a schematic view of an influence of a change of loading on a rolling circumference analysis variable from a rolling circumference analysis; and

FIG. 3 schematically shows an influence of a change of loading on variables from a frequency analysis.

### DETAILED DESCRIPTION OF THE DRAWINGS

Indirect tire pressure loss detection systems make use of two physical effects in order to infer pressure loss. On the one hand, this is the state of affairs that a tire suffering from pressure loss has a smaller circumference compared to the state it is in when no pressure loss is encountered. Consequently, a tire with a reduced tire pressure is rotating at a quicker rate. When monitoring a faster rotating wheel, pressure loss can be inferred by correspondingly producing the ratio of the wheel rotational speeds of the four wheels of a vehicle. The second physical effect founds on the change of the oscillation properties of the system tire-wheel rim-vehicle body during pressure loss. In particular the torsion natural frequency in the range of about 40 hertz is responsive to pressure and can be evaluated by a frequency analysis.

A loading or a change of loading causes re-distribution of the wheel loads. This can cause an increase of the wheel load at one or more wheels. The following is the effect on a rolling circumference analysis or a frequency analysis of the tires:

Rolling Circumference Analysis

A rolling circumference analysis variable ΔU, in particular a difference in rolling circumferences, reacts to an increased wheel load similar to pressure loss on the tire where the wheel load was increased in proportion to the other tires. A separation between a change of wheel load and pressure loss is not possible. This can augment the risk of false alarms in the tire pressure monitoring system especially in learning operations with the vehicle unloaded and a later travel with the vehicle loaded.

Frequency Analysis:

In the frequency analysis, an increase in loading does not lead to influencing the natural frequency fₙₐₜᵤᵣₐₗ, however, to an increase in energy in the spectrum and a more distinct configuration of the natural frequency fₙₐₜᵤᵣₐₗ, i.e. a greater amplitude A in the natural frequency fₙₐₜᵤᵣₐₗ. Driving on a road with increased stimulation energy (e.g. a rougher road surface) can also provoke this effect. It is therefore preferred to consider the ratio of the energies/distinctness of the natural frequency between front wheels and rear wheels rather than reviewing the absolute energy/distinctness of the natural frequency/frequencies.

Thus, the invention is based on the idea that a change of loading of the vehicle acts differently on the two physical effects described hereinabove. When using the method of the invention, a change of the loading is detected only by way of an analysis of the wheel rotational speed signals. The combined evaluation of the data being obtained by a rolling circumference analysis and a frequency analysis of the tires renders it possible to infer a change of loading therefrom. The combination of the two effects allows detecting a change of loading and concluding the wheel load distribution therefrom.

FIG. 1 shows the method of the invention in a schematic flow chart. In block 1, quantities ωᵢ which relate to the rotational speeds of the wheels are determined by the wheel speed sensors existing in an anti-lock system, for example. Subsequently, the quantities ωᵢ are used to perform a rolling circumference analysis (block 2) and a frequency analysis (block 3) of individual or all of the wheels. The results of the two analyses are combined and evaluated in block 4 in order to detect a change of loading of the vehicle.

Hereinbelow, embodiments of the method of the invention will be described. A loading of the rear axle is assumed by way of example, and the method of the invention will be explained with reference to this example of rear-axle loading.

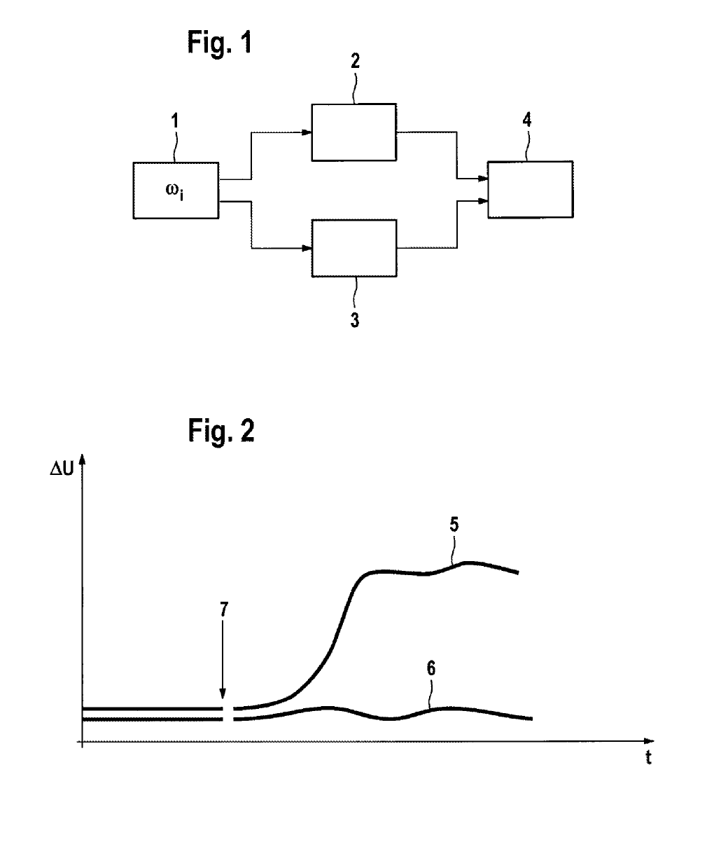

FIG. 2 schematically illustrates a variation of two rolling circumference analysis variables ΔU from a rolling circumference analysis as a function of time t. Curve 5 reflects the variation of the rolling circumference analysis variable ΔU for the rear axle and curve 6 reflects the variation of the rolling circumference analysis variable ΔU for the front axle. The vehicle stands still at time 7 and is loaded on the rear axle.

The circumference of the rear wheels will change due to the increase in loading on the rear axle, it becomes smaller. Consequently, the rolling circumference analysis variable ΔU for the rear axle will change as well relative to its value before the change of loading at time 7 (see curve 5).

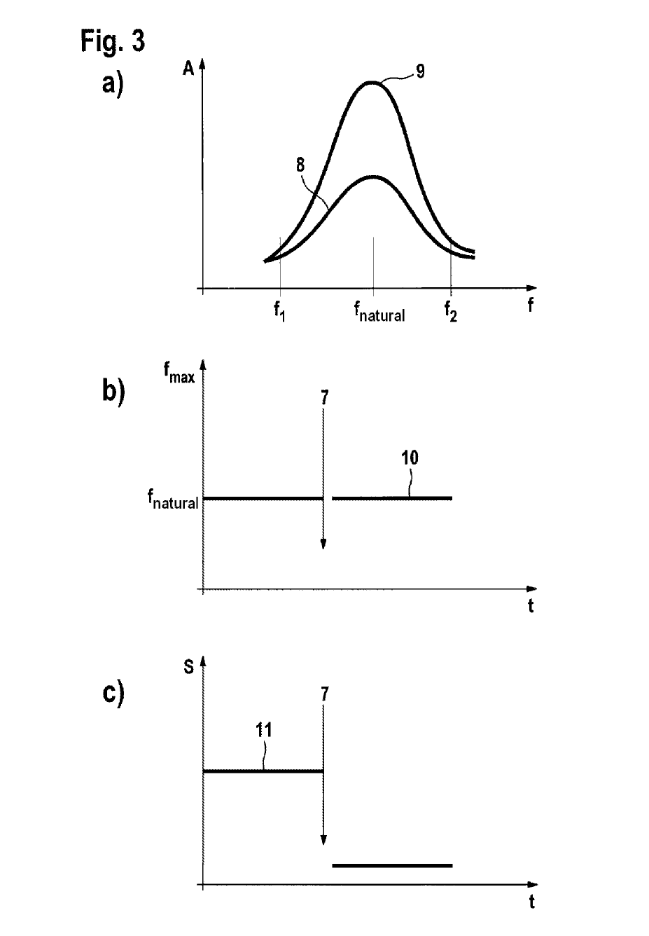

FIG. 3 schematically shows the effects of a change of loading on characteristic quantities of a frequency analysis of a rear tire. FIG. 3a is a schematic view of two frequency spectra of a torsion oscillation of a rear tire. To this end, the amplitude A of the oscillation is illustrated as a function of the frequency f of the oscillation. Curve 8 represents by way of example a frequency spectrum before the change of the loading, while curve 9 represents a frequency spectrum after the change of loading at time 7. The frequency position of the maximum of the frequency spectrum fₘₐₓ is also referred to as natural frequency fₙₐₜᵤᵣₐₗ-FIG. 3b shows the maximum of the frequency spectrum fₘₐₓ as a function of time t. Curve 10 represents the natural frequency fₙₐₜᵤᵣₐₗ of the rear tire as a function of time, with the vehicle being at standstill at time 7 and being loaded on the rear axle. FIG. 3c is a schematic view of a quantity S, which represents the ratio of the spectral energies in the natural frequency spectra of front wheels to rear wheels as a function of time t. Curve 11 reflects the time variation of the quantity A, with the vehicle being at standstill at time 7 and being loaded on the rear axle. The spectral energy in the range of f₁ to f₂ around the natural frequency fₙₐₜᵤᵣₐₗ is used as an indicator of the spectral energy by way of example. According to another embodiment, the amplitude of the natural frequency A(fₙₐₜᵤᵣₐₗ) is used as an indicator of the spectral energy according to another embodiment.

The change of loading does not change the natural frequency fₙₐₜᵤᵣₐₗ. It is roughly equal before and after the change of loading at time 7 (see curve 10). However, the change of loading leads to a more distinct configuration of the natural frequency of the rear wheels (comparison of curves 8 and 9), i.e. the amplitude A in the range of f₁ to f₂ around the natural frequency fₙₐₜᵤᵣₐₗ will rise after the loading. This corresponds to a rise of the spectral energy in the range of f₁ to f₂ around the natural frequency fₙₐₜᵤᵣₐₗ. The ratio S of the spectral energies of front wheels to rear wheels will thus decrease, as is shown in curve 11.

After a standstill (time reference), when pressure loss at the rear axle is indicated by a rolling circumference analysis variable ΔU (see FIG. 2) and a natural frequency analysis does not show a significant displacement of the natural frequency fₙₐₜᵤᵣₐₗ at the rear axle (see FIG. 3b), a possible change of loading is considered to prevail.

In another embodiment, the distinctness of the frequency spectra of the wheels is additionally (optionally) taken into consideration. To this end, a reference quantity which represents the absolute value of the energy or the distinctness of the spectrum for the rear wheel or the rear wheels (e.g. averaged) is evaluated compared to a previously learnt value, or the change of a ratio of front axle to rear axle of such a reference quantity is evaluated. In the latter case, the quantity can be configured irrespective of road conditions.

In the capacity of the reference quantity for the spectral energy of a single spectrum, for example, either the amplitude A of the spectrum in the natural frequency fₙₐₜᵤᵣₐₗ or the energy content E of the frequency spectrum in an appropriate range is used, e.g. the integral with respect to the amplitude values A(f) in a frequency range of f₁ to f₂ around the natural frequency fₙₐₜᵤᵣₐₗ:

E=∫_{f1}^{f2}(A(f))²df.

After standstill, when a rolling circumference analysis variable ΔU indicates pressure loss at the rear axle, a natural frequency analysis does not show a significant displacement of the natural frequency fₙₐₜᵤᵣₐₗ at the rear axle, and additionally either the absolute value of the energy/the distinctness of the spectrum at the rear wheels compared to a previously learnt state has risen or the ratio of this quantity from the front to the rear has changed, then a possible change of loading is considered to prevail.

It is furthermore advisable for a detailed evaluation to determine calibration values related to tires and the vehicle for the different load scenarios. To this end, for example, calibration values for the natural frequencies, amplitude ratios, learning temperatures and rolling circumferences are learnt and saved in the control unit. These values form the reference values with which the additional values are compared during driving.

The load detection of the invention is employed in
vehicle control systems,
indirect tire pressure loss detection systems, and
direct tire pressure loss detection systems.

In an indirect tire pressure loss detection system, which is based on rolling circumference analysis and frequency analysis, a pressure loss warning is initially suppressed in another embodiment when a change of loading is identified, and it is then initiated that the system learns in compensation values, especially for the values from the rolling circumference analysis. The pressure loss warning is released again after compensation has taken place.

In addition, the method of load detection of the invention can be used for further improvement or plausibilisation of other load detection methods.

According to another embodiment, the method of the invention for the detection of loading is supplemented by information from a directly measuring tire pressure monitoring system. Thus, the information from a rolling circumference analysis and a frequency analysis of the wheels and the information from a direct pressure measuring system are e.g. taken into consideration for the detection of loading and/or a change of loading.

1-10. (canceled)

11. A method for the detection of the loading condition of a motor vehicle comprising the steps of
analysing the vehicle's rotational wheel behavior and determining the vehicle's loading condition based the rotational wheel behavior, and providing output information about the loading condition to an electronic system.

12. The method as claimed in claim 11, wherein the rotational wheel behavior is analysed by determining a natural frequency of at least one wheel in a frequency analysis.

13. The method as claimed in claim 12, wherein the loading condition is determined by combining at least one piece of information of a rolling circumference analysis of the wheels with at least one piece of information of a frequency analysis of the natural oscillation behavior of at least one wheel.

14. The method as claimed in claim 12, comprising the steps of determining, for at least one wheel, at least one reference quantity which is an indicator of the configuration of the natural frequency of the at least one wheel, and processing this at least one reference quantity to determine the loading condition.

15. The method as claimed in claim 14, wherein the at least one reference quantity includes energy contents of the spectra in the ranges of the natural frequencies of individual wheels and wherein the processing includes calculating at least one ratio between reference quantities.

16. The method as claimed in claim 14,
wherein the processing includes calculating a ratio between at least one reference quantity of at least one front wheel and at least one reference quantity of at least one rear wheel.

17. The method as claimed in claim 12,
wherein the frequency analysis comprises a temperature compensation.

18. The method as claimed in claim 11,
wherein the method is performed only after an activation signal.

19. The method as claimed in claim 11,
wherein the electronic system is a member of the group consisting of an anti-lock system, an electronic stability program, and tire pressure monitoring system.

20. The method as claimed in claim 11,
comprising the additional intermediate steps of
measuring vehicle tire pressure and
supplying the information on the tire pressure for calculating the loading condition.
